(19) United States
(12) Patent Application Publication
(10) Pub. No.: US 2023/0400988 A1
(43) Pub. Date: Dec. 14, 2023

(54) PRESERVATION OF VOLATILE DATA IN DISTRESS MODE

(71) Applicant: Western Digital Technologies, Inc., San Jose, CA (US)

(72) Inventors: Ramanathan Muthiah, Bangalore (IN); Julian Vlaiko, Kfar Saba (IL); Judah Gamliel Hahn, Ofra (IL)

(21) Appl. No.: 17/839,712

(22) Filed: Jun. 14, 2022

(51) Int. Cl. G06F 3/06

(52) U.S. Cl. CPC G06F 3/0619; G06F 3/0647; G06F 3/0685

(57) ABSTRACT

A data storage device having improved protections for in-flight data during a safety event, such as an autonomous-driving-vehicle collision. In an example embodiment, in response to a distress-mode indication signal, the device controller operates to prioritize more-recent data with respect to older counterparts of the same data stream for flushing from the volatile-memory buffers to the non-volatile memory. In addition, the device controller may operate to positively bias the flushed data towards better survivability and/or more-reliable routing.

### FIELD

This application relates generally to data storage devices, and more particularly but not exclusively, to data handling in data storage devices in response to a failure or near-failure condition.

### BACKGROUND

This section introduces aspects that may help facilitate a better understanding of the disclosure. Accordingly, the statements of this section are to be read in this light and are not to be understood as admissions about what is in the prior art or what is not in the prior art.

Computer systems typically use a combination of volatile memory (VM) and non-volatile memory (NVM). Examples of VM include Dynamic Random-Access Memory (DRAM) and Static Random-Access Memory (SRAM). When power is removed, VM typically loses data stored therein in a very short period of time.

For example, an autonomous driving vehicle (ADV) may typically have many sensors assisting in the ADV driving. In case of an accident, collision, or near collision involving the ADV, there may be a benefit from reviewing the sensor data recorded just prior to and/or during the accident to assist in potentially determining the cause of the accident, and/or whether there may have been a vehicle failure. However, when the accident causes a power loss or other system failure, the data temporarily stored in the ADV's volatile memory may disadvantageously be lost.

### SUMMARY

Disclosed herein are various embodiments of a data storage device having improved protections for in-flight data during a safety event, such as an ADV collision. In an example embodiment, in response to a distress-mode indication signal, the device controller operates to prioritize more-recent data with respect to older counterparts of the same data stream for flushing from the VM buffers to the NVM. In addition, the device controller may operate to positively bias the flushed data towards better survivability and/or more-reliable routing.

According to an example embodiment, provided is a data storage device, comprising: a non-volatile memory; and a controller coupled to the non-volatile memory, the controller being configured to: manage transfer of data from a volatile memory to the non-volatile memory in at least a first operating mode and a second operating mode; in response to an indication of a safety event, transition the data storage device from operating in the first operating mode to operating in the second operating mode; and for the second operating mode, schedule a first portion of the data to be transferred from the volatile memory to the non-volatile memory before a second portion of the data, the first portion having a first priority, the second portion having a lower second priority. In various embodiments, the first and second portions can be portions of the same data stream or of different data streams.

According to another example embodiment, provided is a data storage device, comprising: a non-volatile memory; and an electronic controller configured to manage transfer of data from a volatile memory to the non-volatile memory in at least a first operating mode and a different second operating mode, the electronic controller being configured to: in response to an indication of a safety event, transition the data storage device from operating in the first operating mode to operating in the second operating mode; and for the second operating mode, schedule a first portion of the data to be transferred from the volatile memory to the non-volatile memory before a second portion of the data, the first portion being a portion of a first data stream having a first priority, the second portion being a portion of a second data stream having a lower second priority.

According to yet another example embodiment, provided is a method performed by a data storage device, the method comprising: receiving, with an electronic controller, an indication of a safety event; transitioning, with the electronic controller, the data storage device from operating in a first operating mode to operating in a different second operating mode in response to the receiving; and scheduling, with the electronic controller, in the second operating mode, a first data portion to be transferred from the volatile memory to the non-volatile memory before a second data portion, the first data portion having a first priority, the second data portion having a lower second priority.

According to yet another example embodiment, provided is an apparatus, comprising: means for receiving an indication of a safety event; means for transitioning a data storage device from operating in a first operating mode to operating in a different second operating mode in response the indication being received; and means for scheduling, in the second operating mode, a first data portion to be transferred from the volatile memory to the non-volatile memory before a second data portion, the first data portion having a first priority, the second data portion having a lower second priority.

Various aspects of the present disclosure provide for improvements in data storage devices. The present disclosure can be embodied in various forms, including hardware or circuits controlled by software, firmware, or a combination thereof. The foregoing summary is intended solely to give a general idea of various aspects of the present disclosure and does not limit the scope of the present disclosure in any way.

### BRIEF DESCRIPTION OF THE DRAWINGS

FIG. 1 is a block diagram illustrating an example system in which various embodiments may be practiced.

FIG. 2 is a flowchart illustrating a method that is implemented in the system of FIG. 1 according to various embodiments.

FIG. 3 is a block diagram illustrating example operations of the method of FIG. 2 according to an embodiment.

FIG. 4 is a flowchart illustrating a method that is implemented using an electronic controller of the system of FIG. 1 according to various embodiments.

### DETAILED DESCRIPTION

In the following description, numerous details are set forth, such as data storage device configurations, controller operations, and the like, in order to provide an understanding of one or more aspects of the present disclosure. It will be readily apparent to one skilled in the art that these specific details are merely exemplary and not intended to limit the scope of this application. In particular, the functions associated with the controller can be performed by hardware (for example, analog or digital circuits), a combination of hardware and software (for example, program code or firmware stored in a non-transitory computer-readable medium that is executed by a processor or control circuitry), or any other suitable means. The following description is intended solely to give a general idea of various aspects of the present disclosure and does not limit the scope of the disclosure in any way.

In autonomous (e.g., ADV) applications, the corresponding system can typically operate in different modes, and one of those modes, e.g., a mode corresponding to events classified as safety events, may be referred to as “distress mode.” For example, when the system's sensors predict or detect a crash, the system may enter a distress mode. Critical functional safety data are typically defined at the source and may temporarily be buffered in a system DRAM. Upon a safety event, such as “hard” braking or impact, the system may operate to flush high-resolution data to a solid-state-drive (SSD) space characterized by a relatively high quality of service (QoS), such as a Single Level Cell (SLC) NAND partition.

SSDs may have different priority levels assigned to different types of data that can be flushed to the NAND partitions thereof in power-loss, failure, or near-failure events, e.g., using the energy available in backup super-capacitors. However, in addition to the power-supply limitations, the time available to distress-mode memory operations may also be very limited, e.g., because a crash may impact data-storage operations in other ways beyond power disruptions. Despite the high-QoS NAND partition being used for distress-mode memory operations, some of the buffered data might nevertheless be lost due to the time limitations. The latest data portions may especially be vulnerable to such loss in first-in/first-out (FIFO) buffers. However, such latest data portions may typically have the highest pertinent-information content regarding the corresponding safety event.

The above-indicated and possibly some other related problems in the state of the art may beneficially be addressed using various embodiments disclosed herein. According to an example embodiment, the host may send a distress-mode indication signal to the corresponding data-storage device. In response to the received distress-mode indication signal, the device controller may operate to prioritize more-recent data with respect to older counterparts of the same data stream for flushing from the VM buffers to the NVM. In addition, the device controller may operate to positively bias the flushed data towards better survivability and more-reliable routing.

For example, in a first aspect, a data-storage device may have an event-driven arbitration mechanism and a data-path management entity that implement processing based on a precondition and a post-condition with respect to the safety event. The precondition enacts an arbitration strategy favoring optimal utilization of the memory during normal operation. This arbitration strategy may typically treat the priorities of various data streams and control structures as ancillary factors or non-factors. The post-condition enacts a different arbitration strategy during the distress mode, where the priorities of various data streams and control structures are treated as more-important factors than the optimal utilization of the memory. This arbitration strategy may cause rescheduling of the transfer to the NVM of some volatile data and may also cause the system to drop (discard or let vanish) some parts of the volatile data altogether.

In one example scenario, the data-storage device may explicitly reverse the execution order of inflight data (i.e., the data buffered prior to the time of the safety event, e.g., prior to the assertion time of the distress-indication signal, and still unflushed to the NVM). Under the reversed order, last blocks of data are flushed to the NVM first, e.g., in a last-in/first-out (LIFO) order. In this manner, the data presumably having more-valuable information with respect to the safety event are secured, possibly at the cost of losing some other, presumably less-valuable data from the same data stream. In some embodiments, the priority level of explicit host-system requests for directing data to a high-QoS partition may remain unchanged in the distress mode, i.e., remain the same as in the normal operating mode.

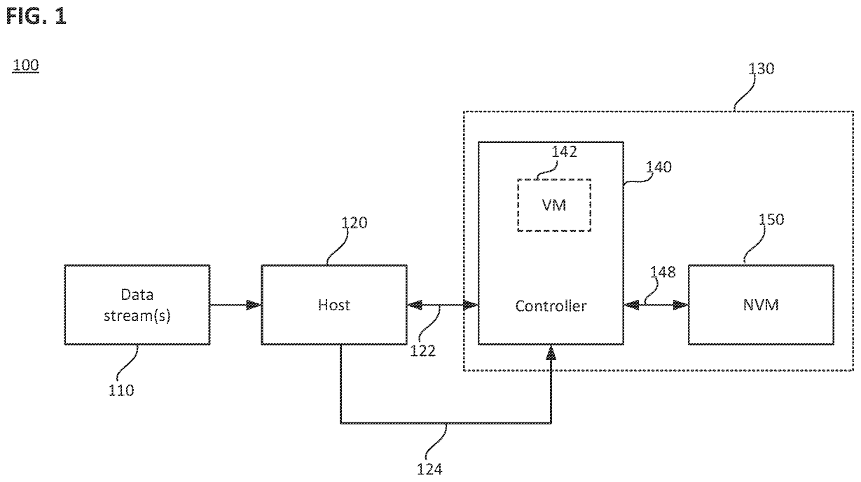

FIG. 1 is a block diagram illustrating an example system 100 in which various embodiments may be practiced. In some embodiments, system 100 may be a part of on-board electronics of an ADV. Other applications of system 100 are also possible, for example, system 100 may be applicable to any electronic device that that may be critically affected by a power loss.

System 100 includes a data storage device 130 connected to a host device 120 by way of a communication path 122. In an example embodiment, communication path 122 can be implemented using suitable interface circuitry at the controller end of communication path 122, an electrical bus, a wireless connection, or any other suitable data link. Host device 120 is further connected to receive one or more data streams 110. Some of data streams 110 may carry sensor data, such as one or more streams of camera data, radar data, lidar data, sonar data, laser measurements, tire pressure monitoring, GPS data, inertial sensor data, accelerometer data, and crash-sensor data. One or more of the data streams 110 may also carry ADV system data, control information, and other systemically crucial types of data. In some embodiments, data storage device 130 is an SSD.

Data storage device 130 includes an electronic controller 140 and an NVM 150. NVM 150 typically includes semiconductor storage dies (not explicitly shown in FIG. 1), which may include any one type or any suitable combination of NAND flash devices, NOR flash devices, and other suitable non-volatile memory devices. Controller 140 may include a volatile memory (VM) 142 configured to buffer portions of the data stream(s) 110 and other data received from host device 120. In some embodiments, host device 120 may similarly include a volatile memory analogous to VM 142.

In operation, host device 120 may apply one or more control signals 124 to controller 140. One of such control signals 124 may be the above-mentioned distress-mode indication signal. For example, the distress-mode indication signal 124 can be a 1-bit signal, with a first binary value thereof being used to configure data storage device 130 to operate in the normal operating mode, and with a second binary value thereof being used to configure data storage device 130 to operate in the distress mode. In response to a safety event, such as collision or near collision inferred or affirmatively detected based on one or more of data stream(s) 110, host device 120 may assert (e.g., flip from 0 to 1) the distress-mode indication signal 124. In response to the assertion, controller 140 may cause data storage device 130 to perform various distress-mode operations, e.g., as described in more detail below. For example, buffering of new host data and data stream(s) 110 may be suspended, and VM 142 may be configured to flush data buffered therein into NVM storage 150 in a manner consistent with the above-mentioned post-condition.

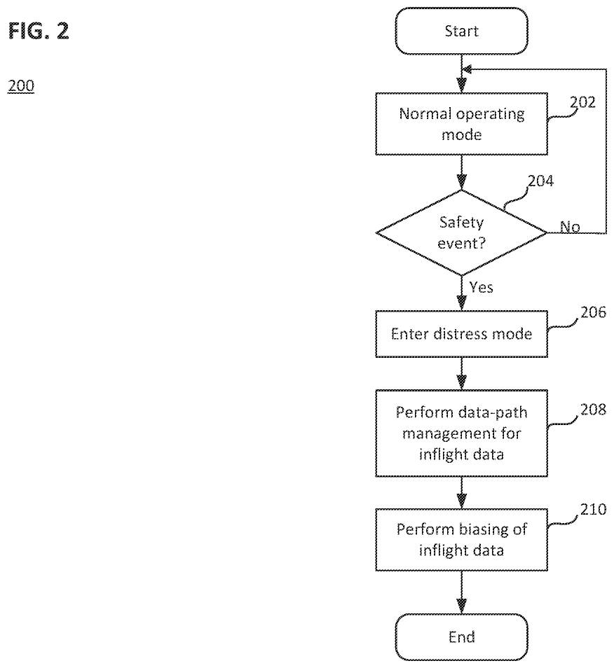

FIG. 2 is a flowchart illustrating a method 200 that is implemented in system 100 according to various embodiments. For example, method 200 manages transfer of data from VM 142 to NVM 150. For illustration purposes and without any implied limitations, method 200 is described in reference to two operating modes, i.e., a normal operating mode and a distress mode. In various embodiments, system 100 may be operable in other operating modes as well, e.g., in three or more different operating modes. In such embodiments, system 100 may transition into the distress mode from a mode other than the normal operating mode.

Method 200 includes the system 100 executing various operations of the normal operating mode (at block 202). The normal operating mode typically includes a set of operations executed in a manner consistent with the precondition and typically geared towards achieving optimal utilization of data storage device 130. Such optimal utilization may be directed, e.g., at maximizing the effective data throughput between host 120 and NVM 150, balancing the data throughput and the input/output throughput of communication path 122, and/or other pertinent performance objectives.

Method 200 includes the system 100 monitoring directed at detecting a safety event (at decision block 204). For example, when a safety event is not detected (“No” at decision block 204), system 100 does not assert the distress-mode indication signal 124 and continues executing various operations of the normal operating mode (at block 202). When a safety event is detected (“Yes” at decision block 204), system 100 asserts the distress-mode indication signal 124 to cause system 100 to enter the distress mode (at block 206). As already mentioned above, the distress mode differs from the normal operating mode in that a different arbitration strategy is typically enacted during the distress mode. For example, different individual priorities of data streams 110 may typically be taken into account and treated as more-important factors than the above-mentioned optimal utilization of data storage device 130.

Method 200 includes the system 100 performing data-path management for inflight data (at block 208). For example, data-path-management operations of block 208 may include the system 100 determining availability of backend bandwidth, i.e., the bandwidth corresponding to data paths 148 between controller 140 and NVM 150. The data-path-management operations of block 208 may also include determining availability of power for transmitting data from VM 142, by way of physical data paths 148, to NVM 150. The availability of power may depend on how much energy is presently held in the backup super-capacitors of data-storage device 130 and may further depend on the quota of that energy allocated to the VM-to-NVM data flushing.

When sufficient power and backend bandwidth are available, data-path-management operations of block 208 may further include forming or logically rearranging a flushing queue for flushing data from VM 142 to NVM 150 in the order based on data-stream priority. For example, when a first one of the data streams 110 has a higher priority than a second one of the data streams 110, the buffered portion of the first data stream may be scheduled to be flushed from VM 142 to NVM 150 before the buffered portion of the second data stream. Suitable additional arbitration criteria can be used to determine the relative flushing order for two data streams 110 having the same nominal priority.

When either the power or the backend bandwidth is deemed to be insufficient, e.g., by the firmware and/or other pertinent circuitry of controller 140, the data-path-management operations of processing block 208 may include flushing-queue adjustments, such as excluding from the flushing queue some of the data buffered in VM 142. For example, buffered portions of data streams of relatively low priority may be excluded first. The excluded volume of data may be selected by controller 140 such that the available power and backend bandwidth are sufficient for handling the remaining part of the flushing queue. The excluded volume of data may be dynamically adjusted (e.g., increased or decreased) by controller 140 based on the projected power/bandwidth availability.

The data-path-management operations of block 208 may also include changing the order of the data blocks of a selected data stream 110 in the flushing queue. For example, the order may be changed from the FIFO order to the LIFO order. In another embodiment, any suitable change of the order in the flushing queue may be implemented, with the change being generally directed at increasing the probability of survival for the relatively more-important data to be flushed from VM 142 to NVM 150 before the loss of power or the occurrence of some other critical failure in system 100. In one example, the order change may be such that probable loss of buffered data is approximately minimized, which may depend on various physical and/or configuration parameters, such as the buffer size, the number of data streams 110, and the time between the assertion time of the distress-mode indication signal 124 and the estimated failure time, to name a few.

Method 200 also includes the system 100 biasing inflight data for better survivability (at block 210). In an example embodiment, the biasing operations of block 210 may be directed at increasing the MTTF (mean time to failure) corresponding to a data block of in-flight data. Several non-limiting examples of such operations are: (i) using a stronger error-correction code (ECC) than the ECC used in the normal operating mode; (ii) using more XOR blocks per data block in NVM 150 than in the normal operating mode; (iii) storing duplicates of the same data block on different NAND dies of NVM 150; and (iv) directing buffered data to a higher QoS partition of NVM 150 than in the normal operating mode. Herein, the term “stronger ECC” refers to an error-correction code of a greater error-correction capacity or limit. A higher QoS partition of NVM 150 may typically have memory cells having fewer levels than other memory cells. For example, SLC partitions may on average exhibit fewer errors than multi-level cell (MLC) partitions and, as such, may be preferred in implementations of high-QoS partitions.

In some embodiments of method 200, one of the blocks 208, 210 may be absent. In some embodiments of method 200, the processing of block 204 may include the host 120 sending a request to controller 140 to write data to a high-QoS partition of NVM 150. Such a request may be used in lieu of the assertion of the distress-mode indication signal 124 in embodiments wherein high-QoS partitions of NVM 150 are reserved exclusively for data flushing in response to a safety event. In some embodiments, for a given stream 110, controller 140 may dynamically change the level of data biasing and applied data routing mechanisms by repeating some or all operations of the blocks 208, 210 at different times after the commencement time of the distress mode (at blocks 204, 206). In some embodiments, certain operations performed in the blocks 208, 210 may be customized for a specific application of system 100 and/or to meet customer specifications.

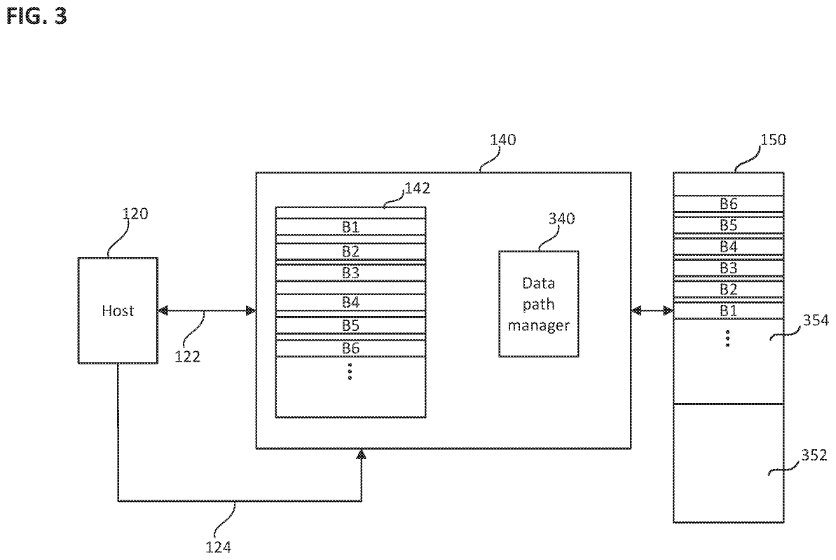

FIG. 3 is a block diagram pictorially illustrating some example operations of the blocks 208, 210 of method 200 according to an embodiment. In the illustrated example, just before the assertion of the distress-mode indication signal 124, the VM buffer 142 has a data queue having data blocks B1-B6 of one of data streams 110 queued therein for transfer to a regular partition 352 of NVM 150 in the FIFO order. Data block B1 is the first data block in the flushing queue, and data block B6 is the last data block in the flushing queue.

After the distress-mode indication signal 124 is asserted, the processing of block 208 causes a logical reordering of the flushing queue from the FIFO order to the LIFO order. The processing of block 210 further causes a data-path management entity 340 of controller 140 to change the destination for the queued data blocks B1-B6 from the regular partition 352 of NVM 150 to a high-QoS partition 354 of NVM 150. As a result, data block B6 is flushed first from the VM buffer 142 to the high-QoS partition 354; data block B5 is flushed second from the VM buffer 142 to the high-QoS partition 354; data block B4 is flushed next from the VM buffer 142 to the high-QoS partition 354, and so on.

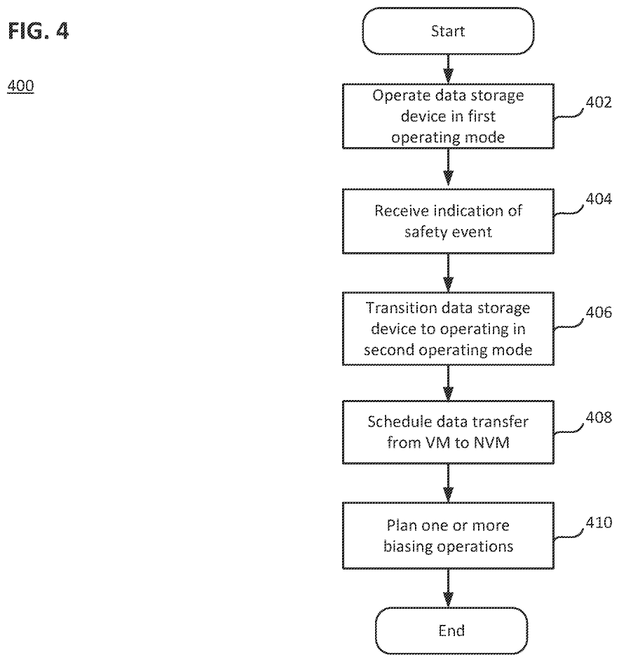

FIG. 4 is a flowchart illustrating a method 400 that is implemented using controller 140 according to various embodiments. Method 400 can be implemented, e.g., using a processor and/or other pertinent circuitry of controller 140 executing firmware instructions to generate one or more control signals for the VM buffer 142 and/or for the NVM 150 (also see FIGS. 1 and 3).

Method 400 includes the controller 140 operating data storage device 130 in a first operating mode (at block 402). In some examples, the first operating mode can be the above-mentioned normal operating mode. In some other examples, the first operating mode can be some other operating mode different from each of the normal and distress operating modes.

Method 400 includes the controller 140 receiving an indication of a safety event (at block 404). For example, the above-mentioned distress-mode indication signal 124 may be asserted by host 120. Accordingly, controller 140 may detect (at block 404) a state change of signal 124.

Method 400 includes the controller 140 transitioning the data storage device 130 (at block 406) from operating in the first operating mode to operating in a second operating mode. For example, the second operating mode can be the above-mentioned distress mode. The transitioning (at block 406) may be performed by the controller 140 in response to the receiving of the indication of the safety event (at block 404).

Method 400 includes the controller 140 scheduling data transfer from VM 142 to NVM 150 (at block 408), e.g., for various portions of one or more data streams 110 buffered in VM 142. Such scheduling may include various scheduling operations performed in the first operating modes and in the second operating mode. For example, in some cases, the controller 140 scheduling the data transfer (at block 408) includes scheduling, in the second operating mode, a first portion of the data to be transferred from VM 142 to NVM 150 before a second portion of the data, the first portion being a portion of a first data stream having a first priority, the second portion being a portion of a second data stream having a lower second priority. In some cases, the controller 140 scheduling the data transfer (at block 408) includes: (i) scheduling, in the first operating mode, data blocks of the first or second portion to be transferred from the volatile memory to the non-volatile memory in a first order; and (ii) scheduling, in the second operating mode, the data blocks to be transferred from the volatile memory to the non-volatile memory in a different second order. For example, the first order can be a first-in/first-out order, and the second order can be a last-in/first-out order. In some examples, the second order can be a reverse order with respect to the first order.

Method 400 includes the controller 140 planning, in the second operating mode, one or more biasing operations directed at increasing a mean time to failure corresponding to a data block of the data relative to the first operating mode (at block 410). Such biasing operations may include, for example, applying a stronger ECC than the ECC used in the first operating mode and/or directing buffered data to the partition 354 instead of the partition 352 (also see FIG. 3).

Some embodiments may benefit from at least some features disclosed in the book by Rino Micheloni, Luca Crippa, and Alessia Marelli, “Inside NAND Flash Memories,” Springer, 2010, which is incorporated herein by reference in its entirety.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain implementations and should in no way be construed to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

Unless explicitly stated otherwise, each numerical value and range should be interpreted as being approximate as if the word “about” or “approximately” preceded the value or range.

The use of figure numbers and/or figure reference labels (if any) in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

“SUMMARY” in this specification is intended to introduce some example embodiments, with additional embodiments being described in “DETAILED DESCRIPTION” and/or in reference to one or more drawings. “SUMMARY” is not intended to identify essential elements or features of the claimed subject matter, nor is it intended to limit the scope of the claimed subject matter.

“ABSTRACT” is provided to allow the reader to quickly ascertain the nature of the technical disclosure. It is submitted with the understanding that it will not be used to interpret or limit the scope or meaning of the claims. In addition, in the foregoing “DETAILED DESCRIPTION,” it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into “DETAILED DESCRIPTION,” with each claim standing on its own as a separately claimed subject matter.

1. A data storage device, comprising:
a non-volatile memory including a plurality of semiconductor storage dies;
a volatile memory configured to buffer portions of data received from a host device for transfer to the plurality of semiconductor storage dies; and
a controller coupled to the non-volatile memory and to the volatile memory, the controller being configured to:
manage transfer of the data from the volatile memory to the plurality of semiconductor storage dies in at least a first operating mode and a second operating mode;
in response to an indication of a safety event, transition the data storage device from operating in the first operating mode to operating in the second operating mode;
for the first operating mode, schedule a first portion of the data buffered in the volatile memory to be transferred to the plurality of semiconductor storage dies after a second portion of the data buffered in the volatile memory; and
for the second operating mode, reschedule the first portion of the data to be transferred from the volatile memory to the plurality of semiconductor storage dies before the second portion of the data.

2. The data storage device of claim 1,
wherein the first portion of the data has a first priority, and the second portion of the data has a lower second priority; and
wherein, for the first operating mode, the controller is configured to schedule the first portion of the data and the second portion of the data to be transferred from the volatile memory to the non-volatile memory without taking into account the first priority and the second priority to maximize an effective data throughput between the host device and the plurality of semiconductor storage dies.

3. The data storage device of claim 1,
wherein the first portion of the data has a first priority, and the second portion of the data has a lower second priority; and
wherein, for the first operating mode, the controller is configured to schedule the first portion of the data and the second portion of the data to be transferred from the volatile memory to the non-volatile memory without taking into account the first priority and the second priority to balance the effective data throughput, an input data throughput for a communication path connecting the controller to the host device, and an output data throughput for the communication path.

4. The data storage device of claim 1,
wherein the first portion of the data is a portion of a first data stream received by the host device, the first data stream having system data of an autonomous driving vehicle; and
wherein the second portion of the data is a portion of a second data stream received by the host device, the second data stream having sensor data of the autonomous driving vehicle.

5. The data storage device of claim 1,
wherein the non-volatile memory has a first partition and a second partition, the first partition being characterized by a higher quality of service than the second partition; and
wherein the indication of the safety event is a request from the host to write at least a portion of the data into the first partition.

6. The data storage device of claim 1, wherein the indication of the safety event is a bit flip in a control signal supplied to the controller by the host.

7. The data storage device of claim 1, wherein the controller is configured to:
for the first operating mode, schedule data blocks of the first or second portion of the data to be transferred from the volatile memory to the plurality of semiconductor storage dies in a first order; and
for the second operating mode, schedule the data blocks to be transferred from the volatile memory to the plurality of semiconductor storage dies in a different second order.

8. The data storage device of claim 7,
wherein the first order is a first-in/first-out order; and
wherein the different second order is a last-in/first-out order.

9. The data storage device of claim 7, wherein the different second order is a reverse order with respect to the first order.

10. The data storage device of claim 7, wherein the controller is configured to:
for the second operating mode, schedule fewer of the data blocks to be transferred from the volatile memory to the plurality of semiconductor storage dies than for the first operating mode.

11. The data storage device of claim 1, wherein the controller is configured to:
for the second operating mode, plan one or more biasing operations directed at increasing a mean time to failure corresponding to a data block of the data relative to the first operating mode.

12. The data storage device of claim 11, wherein the one or more biasing operations include one or more of:
using a stronger error-correction code than in the first operating mode;
using more XOR blocks in the non-volatile memory for the data block than in the first operating mode; and
storing duplicates of the data block on two or more different semiconductor dies of the non-volatile memory.

13. The data storage device of claim 11, wherein the safety event is an actual or predicted crash of an autonomous driving vehicle that includes the host device, the non-volatile memory, the volatile memory, and the controller.

14. A method performed by a data storage device, the method comprising:
buffering, in a volatile memory, portions of data received from a host device for transfer to a non-volatile memory including a plurality of semiconductor storage dies;
receiving, with a controller coupled to the non-volatile memory and to the volatile memory, an indication of a safety event;
transitioning, with the controller, the data storage device from operating in a first operating mode to operating in a second operating mode in response to the indication being received;
scheduling, with the controller, for the first operating mode, a first portion of the data buffered in the volatile memory to be transferred to the plurality of semiconductor storage dies after a second portion of the data buffered in the volatile memory; and
rescheduling, with the controller, in for the second operating mode, the first portion of the data to be transferred from the volatile memory to the plurality of semiconductor storage dies before the second portion of the data.

15. The method of claim 14, further comprising:
scheduling, with the controller, for the first operating mode, data blocks of the first or second portion of the data to be transferred from the volatile memory to the plurality of semiconductor storage dies in a first order; and
rescheduling, with the controller, for the second operating mode, the data blocks to be transferred from the volatile memory to the plurality of semiconductor storage dies in a different second order.

16. The method of claim 15,
wherein the first order is a first-in/first-out order; and
wherein the different second order is a last-in/first-out order.

17. The method of claim 15, wherein the different second order is a reverse order with respect to the first order.

18. The method of claim 15, further comprising:
scheduling, with the controller, for the second operating mode, fewer of the data blocks to be transferred from the volatile memory to the plurality of semiconductor storage dies than for the first operating mode.

19. The method of claim 14, further comprising:
planning, with the controller, for the second operating mode, one or more biasing operations directed at increasing a mean time to failure corresponding to a data block relative to the first operating mode.

20. An apparatus, comprising:
means for buffering, in a volatile memory, portions of data received from a host device for transfer to a non-volatile memory including a plurality of semiconductor storage dies;
means for receiving an indication of a safety event;
means for transitioning a data storage device from operating in a first operating mode to operating in a second operating mode in response to the indication being received;
means for scheduling, for the first operating mode, a first portion of the data buffered in the volatile memory to be transferred to the plurality of semiconductor storage dies after a second portion of the data buffered in the volatile memory; and
means for rescheduling, for the second operating mode, the first portion of the data to be transferred from a volatile memory to the plurality of semiconductor storage dies before the second portion of the data.
